(19) United States
(12) Patent Application Publication
(10) Pub. No.: US 2002/0114595 A1
(43) Pub. Date: Aug. 22, 2002

(54) Efficient method and system for the installation of data conduit in pre-existing structures

(76) Inventor: Hanan Potash, Austin, TX (US)

Correspondence Address: Kevin L. Daffer, Conley, Rose & Tayon, P.C., P.O. Box 398, Austin, TX, 78767-0398, US

(21) Appl. No.: 09/788,215

(22) Filed: Feb. 16, 2001

(51) Int. Cl. G02B 6/44

(52) U.S. Cl. 385/100

(57) ABSTRACT

A system and method are presented for efficient installation of a data conduit in a previously fluid distribution pipe. In an embodiment, the data conduit may be an optical fiber within a communications network, and the fluid distribution pipe may be a water pipe within the plumbing system of a building. The method assumes no special features or provisions in the building construction, except a standard plumbing system, or similar network of fluid-conveying pipes. Compared to existing fiber installation methods, in which conduit must be placed within walls and ceiling throughout the building, the approach disclosed herein is believed to require less effort and to entail simpler modifications to the building. The use of existing pipes as conduits also enables a convenient technique for routing the optical fiber by using the flow of water to automatically direct a pull cable to the intended exit point.

### BACKGROUND OF THE INVENTION

1. Field of Invention

This invention relates to optical fiber communications, and more particularly, to the installation of communications-grade optical fiber or copper in a previously existing building, among buildings and from curbside to buildings.

2. Description of Related Art

In the near future, digital communications networks are expected to undergo tremendous growth and development. As their use becomes more widespread, there is an attendant need for higher bandwidth. To fill this need, present-day copper wire-based systems will gradually be replaced by fiber optic networks. In fact, standards for such networks, such as the synchronous optical network (SONET, 1G Ethernet, 10G Ethernet, InfiniBand) standard, are either already in place or are about to enter as standards in the near future standard (10G Ethernet, InfiniBand). Optical fiber provides several advantages over copper as a communications medium:

(1) Noise immunity: Unlike copper wire, signals carried over adjacent optical fibers do not interfere with one another—i.e., there is no “crosstalk.” Furthermore, optical fibers are also immune to electrical interference, so fibers may be routed adjacent to electrical wiring without shielding or other special precautions.

(2) Wide bandwidth: SONET/SDH level OC-192 uses a single and multi-mode fiber to carry information at a rate of 9.953 Gigabits per second—more than 120,000 times the information of electronic signals over copper wire. In fact, the actual capacity of a single strand fiber-optic line is above 800 Gbps when the entire optical spectrum (wavelength, colors of light) is used.

(3) No possibility of short circuits: Optical fibers carry photons, not electrical current, so there is no possibility of a damaged fiber creating a fire or shock hazard.

(4) Greater security: Because optical fibers do not carry electrical currents, they generate no external electromagnetic fields or radiation. Therefore, “electronically eavesdropping,” without physically tapping into the fiber, is difficult and complicated.

In the construction of modern office buildings, some provision for optical fiber networks is generally included along with lighting, electricity, ventilation and other basic services. During the design and construction of a new building, it is relatively simple to route and install optical fiber bundles—in most cases, the fiber may be installed along with the electrical or telephone wiring. Older buildings, on the other hand, must be retrofitted with optical fiber.

Equipping pre-existing buildings to support fiber optic communications is often a cumbersome task. Conduits to carry the fiber must first be installed in the walls or ceiling. This frequently involves extensive modifications to the building, or landscape and may be costly and highly disruptive of normal office activities. Once the conduit is installed, the optical fiber must be pulled through. This can also be an arduous and time-consuming activity. Pulling fiber long distances and around corners places mechanical All stress on the fiber and, if done improperly, may even damage it.

It is often necessary to install optical fiber networks between buildings, for example, on a university campus, or within a multi-unit office complex. If there are no pre-existing underground conduits for the fiber, the site will have to be excavated so they can be installed. In this case, the time and expense involved constitute a considerable disadvantage.

In view of the increasing importance of fiber optic, as well as high-speed copper (such as xDSL) communication networks, and considering the difficulties that may be encountered in retrofitting older buildings and sites with optical fiber, it would be desirable if there were an improved method for installing optical fiber or new copper cable in existing office buildings. This method should require less time and labor, and be less expensive and disruptive than existing installation methods.

### SUMMARY OF THE INVENTION

Optical fiber is rapidly replacing copper wire as a medium for communications signals. Among its various advantages, optical fiber can support much higher bandwidth than wire. Unfortunately, many sites are not equipped with fiber optic networks, and must be retrofitted. Conventional installation methods for optical fiber and high-speed copper networks often require extensive and laborious modifications. For example, conduits must typically be placed in the walls and ceiling of buildings to protect the fiber. If more than one building is involved, excavation may even be necessary. Furthermore, it is generally necessary to pull the fibers or copper cable to route them from one point to another. Often, they must be pulled over long distances, around corners or obstacles, etc., which physically stresses the fiber. These problems are, in large part, addressed by a system and method to efficiently install optical fiber or copper cables using existing fluid distribution pipes.

A method is disclosed herein for installing a data conduit between a first and second location within a fluid (water or gas) distribution pipes. The remainder of this discussion will refer to a water distribution system and fiber optic cables. However it should be understood that the invention is equally applicable to gas, sewer and other liquid or gas distribution pipes, and to copper as well as fiber optic cables. The method involves modifying two segments of the pipe to provide entry and exit points for the data conduit. The entry and exit points are typically selected to be as near as possible to the intended locations where access to the fiber is required. In an embodiment, modification of a pipe entails bisecting the pipe and inserting a wye-fitting between the resulting two sections. The wye-fitting may be the type commonly used in plumbing to attach a branch pipe to a main pipe. After the addition of the wye-fitting, the data conduit is introduced into the pipe, through a coupling inserted into the third leg of the wye-fitting. In heavy copper pipes or in iron pipes, the wye-fitting method may be replaced by forming (e.g., by drilling or punching) a small hole in the pipe, into which the coupling is introduced. The coupling may be secured by threading, soldering, gluing, etc. Another embodiment of the method further includes a procedure for routing the data conduit to the desired exit point in the pipe. This is accomplished by inserting a sponge-covered and/or balloon rubber “float” into the pipe at the entry point. In an embodiment, the float is slightly larger then the pipe's diameter and has an oblong shape, with a length about three times its diameter. The float must easily compress to the smallest diameter of fitting in the pipe's length. The float is tethered to a length of lightweight cable. The fluid flowing in the pipe then transports the float (pulling behind it the lightweight cable) from the entry point to the exit point. Once the lightweight cable is routed from the entry point to the exit point, it may be used to pull the data conduit, which typically is a thin copper pipe, through after it.

Also disclosed herein is a system for conducting a data conduit from a first to a second location within a fluid distribution pipe. In an embodiment, the system includes first and second segments of the pipe, which have been modified to allow a data conduit to enter the first segment of the pipe and exit the second. The first and second segments of the pipe are modified by bisecting the pipe segment and inserting the end of each of the resulting sections into one of the three legs of a wye-fitting, or by forming holes in the pipe to provide the entry and exit points for the data conduit (in this case, a balloon float may be preferred). Holes may be drilled or punched in the pipe. Modification may further constitute inserting a coupling into the third leg of the fitting, or into the hole, such that the coupling allows insertion of the data conduit and prevents the fluid from leaking out of the pipe. Couplings may be threaded, soldered, welded or glued to secure them in place. In embodiments discussed herein, the fluid distribution pipe may be a water supply pipe within a building, entering the premises from the curbside, or between multiple buildings, and the data conduit may be an optical fiber, jacketed within flexible (typically copper or plastic) tubing.

A method is also disclosed herein for routing a data conduit from a first location to a second location within a fluid distribution pipe. The method calls for the introduction of the data conduit at entry and exit points along the pipe. In an embodiment, the entry and exit points are first and second pipe segments, in which wye-fittings have been inserted, or into which holes have been placed. The wye-fittings or holes contain couplings, which may receive the data conduit and seal the pipe to prevent fluid leakage. Holes may be formed in the pipe by drilling, punching, etc., and couplings introduced into the pipe may be secured in place by threading, welding, soldering, etc. In an embodiment of the method, the data conduit is an optical fiber, jacketed within flexible metal or plastic tubing, and the existing plumbing in a building (or between buildings) is utilized to route and protect the optical fiber. The method may further include a procedure for routing the data conduit through the fluid distribution pipe, from the entry point to the exit point. The procedure calls for a float to be placed within the pipe at the entry point, attached to which is a lightweight cable. The float is transported along the fluid flow from the entry point (typically behind the main valve) to the desired exit point by the fluid flowing within the pipe. As long as all other fluid exits (taps), but the desired exit taps are closed, the float will exit from the desired location. In so doing, the float pulls the lightweight cable behind it. The lightweight cable may be used to pull the data conduit through the pipe. Note also that this method of cable installation has an automatic security feature—one may not handle the data cable without turning off the fluid (water supply) pressure.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### BRIEF DESCRIPTION OF THE DRAWINGS

Other objects and advantages of the invention will become apparent upon reading the following detailed description and upon reference to the accompanying drawings in which:

FIG. 1a depicts an embodiment of the system and method disclosed herein for routing a data conduit through an existing fluid distribution pipe, with the components shown in an exploded view;

FIG. 1b shows the embodiment of FIG. 1a with the components assembled, as they would appear in actual use;

FIG. 1c shows an alternative embodiment, intended for thick-walled, or steel pipe;

FIG. 2 depicts a typical fiber optic network installation, according to the system and method disclosed herein; and

FIG. 3 illustrates the introduction of a data conduit into a fluid distribution pipe, according to an embodiment of the system and method disclosed herein.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF THE PREFERRED EMBODIMENTS

In recent years there has been tremendous growth in the use of digital communications networks. Rising business and recreational use of the Internet have contributed to this growth. Network users are also demanding higher bandwidth, to handle video and other broadband content increasingly present in network traffic. The escalating requirement for myriad high bit-rate channels has begun to exceed the capacity of the conventional copper wire transmission medium. Instead of wire, future communication networks will employ optical fibers and high-speed copper lines to transmit high-speed communications signals.

There are numerous advantages to sending optical signals over a fiber, as opposed to sending electrical signals over copper wire, such as the immunity of optical fibers to interference and “crosstalk” (i.e., contamination of a given signal by another signal in an adjacent fiber). However, the principal advantage offered by optical fibers is their enormous bandwidth. A single optical fiber presently transports data at a rate of nearly 10 Gbits per second and has a theoretical carrying capacity above 800 Gbps. With Dense Wavelength Division Multiplexing (DWDM). Such high data rates are not possible over significant distances using copper wire. Traditionally, optical fiber has been more expensive than wire. However, because of increased demand and improved production techniques, fiber prices today make it competitive with copper.

For the reasons just stated, we may assume that copper wire communications systems will eventually be replaced by fiber optic networks. Recognizing this fact, architects and construction companies frequently build fiber optic “wiring” into new office buildings, to provide future tenants broadband network access. Fiber installation is not difficult in a building in which its use was anticipated. Channels through which to route the fiber, access panels for service personnel, etc., may all be included in the building design.

On the other hand, the installation of optical fiber networks in older buildings can be difficult and expensive. For example, bringing the fiber cable from the curbside cable or telephone distribution box to the building may require digging new trenches which, apart from impacting the existing landscape, often damages the pipes and cables of existing services. Fibers must be routed through conduits to protect them from damage; since these are not present in an older building, they must first be installed in the walls or ceiling. After installing the conduit, the optical fiber must be pulled through. Pulling fiber long distances and around corners places mechanical stress on the fiber and, if done improperly, may even damage it. Thus, both the modification of the building to accommodate the optical fiber network and the actual installation and routing of the fiber are likely to be costly and time-consuming, and may interfere with normal business activities.

These difficulties are compounded in fiber optic installations involving multiple buildings. For example, it may be necessary to interconnect several buildings on a university campus or within an office complex. In such cases, the fiber must not only be routed within each individual building, but among buildings. If there are no existing underground conduits through which to run the fiber, excavation will be required to install them.

A system and method are disclosed herein for efficiently installing a data conduit, such as optical fiber. The system and method avoid the difficulties described above, and may reduce installation labor and expense, compared with existing methods.

Although the system and method are discussed herein in terms of installing optical fiber in water pipes, it should be understood that the system and method are applicable to other data conduits and fluid pipes. For example, pipes carrying oil or liquefied natural gas may be usable in some embodiments. Other fluids, such as various liquid or gaseous chemicals, may also be suitable, if the reactivity of the chemical is such that the data conduit may be protected and the installation performed safely. In addition to optical fiber, the data conduit routed may include electrical wiring, video cable, or other similar signal carrier.

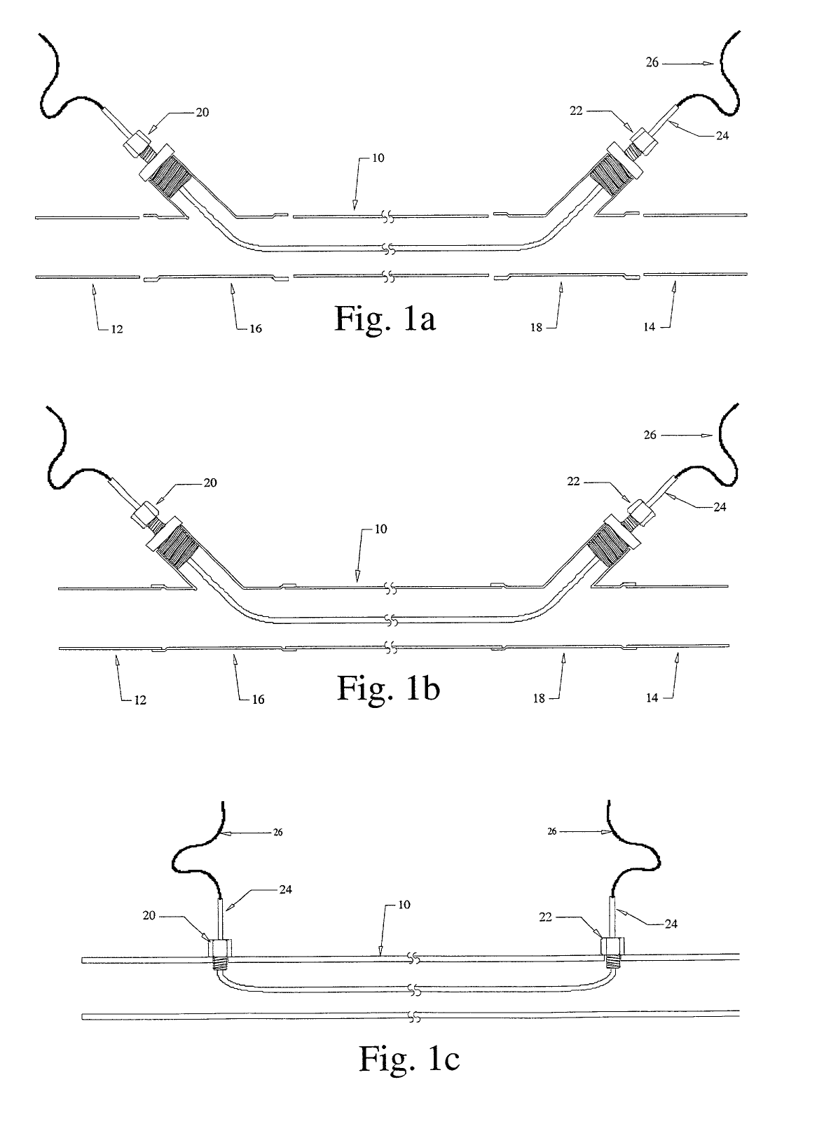

Embodiments of the system and method disclosed herein utilize the existing plumbing system at a site as a convenient conduit for the optical fibers. This eliminates the need to install conduit, and thus avoids major modification of the site. Furthermore, the water pipes used typically belong to the building (home) owner, thus one avoids entanglement with the current easement holder (typically the water supply company). Similarly, easement holders may use this technique to augment their business into data distribution systems. In an embodiment illustrated in FIG. 1a, an exploded view shows the individual components. A cross section of pipe 10 of indeterminate length is depicted in FIG. 1a. A fluid, such as water, enters from the right through pipe section 14 and exits to the left through pipe section 12. In the embodiment of FIG. 1, wye-fitting 16 is inserted between pipe sections 12 and 10, and another wye-fitting 18 between pipe sections 10 and 14. The wye-fittings provide entry and exit points for the optical fiber, and are preferably installed as near as possible to the actual locations where fiber optic service is required. Any type of fitting providing such entry and exit points may be used, although the oblique orientation of the wye-fitting port is believed to be advantageous for this application. Inserting a wye-fitting typically involves cutting and removing a section of the original pipe. In FIG. 1a, for example, pipe sections 10 and 14 may have been a continuous piece of pipe from which a section was removed to permit the insertion of wye-fitting 18. Screwed into the oblique leg of wye-fitting 16 is a reducing coupling 20; similarly, reducing coupling 22 is screwed into wye-fitting 18. A length of flexible tubing 24 enters coupling 22 in wye-fitting 18, runs through the interior of pipe section 10, and emerges from coupling 20 in wye-fitting 16. In an embodiment, the flexible tubing is made of metal, such as copper; however, other materials with suitable characteristics (e.g., plastic) may also be used. Within the flexible tubing 24 is the optical fiber 26. The same components are shown as an assembly in FIG. 1b (all the components retain their item numbers from FIG. 1a). A variant of this arrangement, illustrated in FIG. 1c, may be more suitable for thick-walled pipe, or pipe made of steel rather than a soft material, such as plastic or copper. In such cases, the wye-fittings are omitted and each coupling 22 is introduced directly into a hole formed (e.g., drilled, or punched) in the pipe wall. The coupling may be affixed to the pipe by threading, welding, soldering or gluing it in place. Note that the approach of FIG. 1c avoids having to cut the main pipe section 10.

All of the components in this embodiment may be implemented with standard plumbing hardware, available from a plumbing or hardware supplier. The optical fiber may be mechanically protected within the water pipe 10-14, and kept dry by the flexible tubing 24. The flexible tubing slightly reduces the interior cross sectional area of the water pipe, but its effect on water flow is negligible. An advantage of the present system and method is that plumbing is present in virtually all homes and office buildings. Furthermore, the network of pipes is generally extensive enough to provide readily accessible entry/exit points for the optical fiber. Assume, for example, we want a fiber optic drop in an office on the 15th floor of an office building built in the 1950's. Rather than running the optical fiber throughout the building, we route the fiber from the office to the plumbing in the nearby bathroom, then down to a server on the first floor.

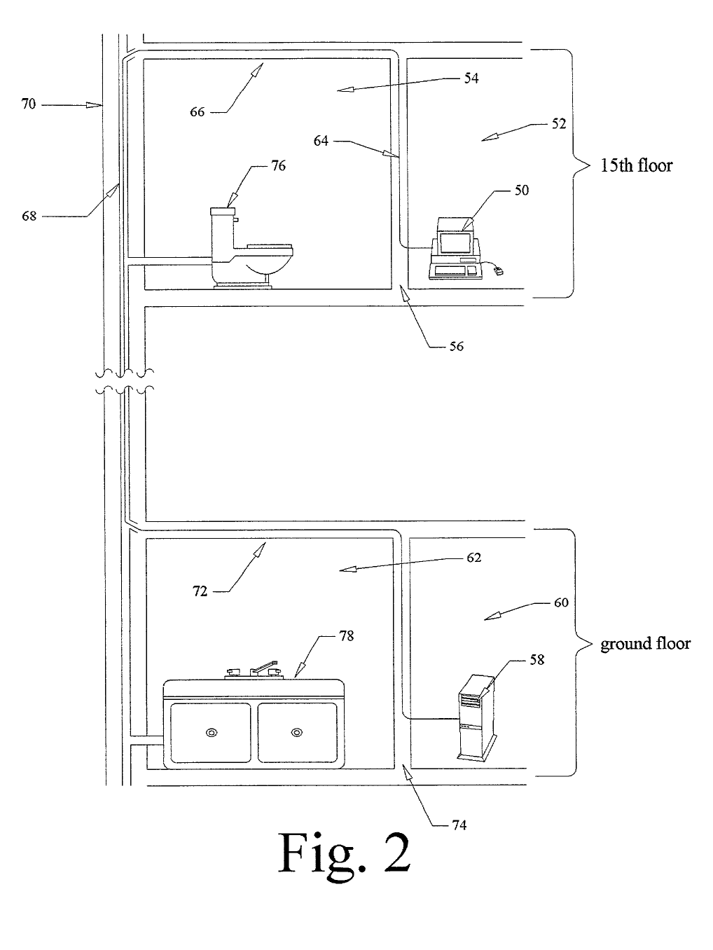

FIG. 2 illustrates an embodiment of the system and method disclosed herein in which a fiber optic network interconnects computers on different floors of an office building. In FIG. 2, a desktop computer 50 in an office 52 on the 15th floor of the building is adjacent to a bathroom 54, separated by a wall 56. A network server 58 sits in another office 60 on the 1^{st} floor of the building. A kitchen 62 is in the next room, separated from the office 60 by a wall 74. A water pipe 68 in the outer wall 70 of the building provides water to a toilet 76 in the 15th floor bathroom 54, and to a sink 78 in the kitchen 62. A fiber optic cable 64 connects the desktop computer 50 on the 15th floor to the network server on the 1^{st} floor. The cable is routed via the plumbing system, according to the system and method disclosed herein.

From desktop computer 50, fiber optic cable 64 passes through the adjacent wall 56 and the ceiling above the bathroom 66. Using a hardware arrangement like that shown in FIG. 1, the optical fiber enters the water pipe 68 in the outer wall 70 of the building on the 15th floor. The fiber exits the water pipe 68 on the first floor, passing through the ceiling 72 above the kitchen 62 to emerge from the wall 74, where it connects to the network server 58. It can be seen from this illustrative embodiment that the fiber is routed though walls and ceilings only for short distances—i.e., from the computer to the nearest water pipe. The major span of fiber, from the 1st to the 15th floor, passes through the pipe 68 in the outer wall 70. Thus, by utilizing the existing plumbing, an optical fiber network may be installed without making major modifications to the building.

A similar scenario could occur if the fiber were installed between two separate buildings. However, instead of being routed through a water pipe from the 15th to the 1st floor, the fiber could pass through an underground water pipe connecting the water supplies of the two buildings. In this case, the labor and expense associated with installing underground conduit for the fiber is avoided by routing the fiber through the existing water pipe. In some instances, this savings may be considerable. For example, if the buildings are widely separated, or if a road passes between them, the cost and inconvenience of installing a completely new fiber path can be enormous. Similarly, the fiber-optic line may be connecting the curbside distribution box where the flexible data pipe enters the home water supply line just past the main valve, and exiting somewhere next to the home or in the home's attic.

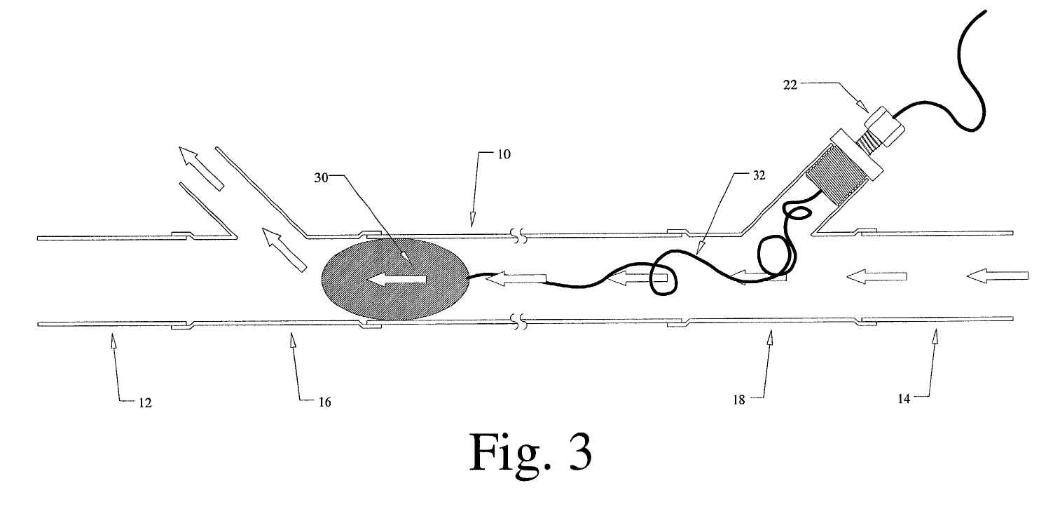

One of the more difficult tasks involved in conventional optical fiber installation is pulling the fibers through conduit. A pull cable must first be passed through the conduit. The cable is then attached to the fiber and used to pull the fiber through after it. It is sometimes necessary to pull the fibers considerable distances, around comers, etc. The force exerted in doing so may be stressful to the fiber, and can result in damage. Advantageously, the method disclosed herein for installation of optical fiber in an existing building may also include a simple technique for introducing the fiber into a water pipe, illustrated in FIG. 3.

FIG. 3 shows many of the same components seen in FIGS. 1a and 1b. Note that the water must be turned off before beginning the following procedure. After separating pipe 10 from pipes 12 and 14, wye-fittings 16 and 18 are installed. Coupling 22 is installed in the oblique leg of wye-fitting 18, while the corresponding leg of wye-fitting 16 is left open. A float 30 is introduced into pipe 10. In an embodiment, the diameter of the float is slightly larger than that of the pipe. The length of the float is about three times its diameter, and it must easily compress to the smallest diameter fitting in the pipe's length. The float is attached to a length of lightweight cable 32, the other end of which is connected to the coupling 22 in wye-fitting 18. When water is allowed to flow through the pipe, it enters pipe section 14 and flows into pipe section 10, in the direction indicated by the white arrows. Since there is no coupling in wye-fitting 16, the water is free to flow out of the pipe 10, as shown. As water flows through the pipe, it carries the float 30 toward the opening in wye-fitting 16. Eventually, the float emerges from this opening, allowing the lightweight cable 32 to be pulled through after it. The water is then turned off again, to permit introduction of the optical fiber (within flexible tubing) into the pipe. The lightweight cable may now be used to pull a heavier cable through the pipe. In turn, the heavier cable pulls through the flexible tubing containing the new copper or optical fiber. The installation is completed by sealing wye-fitting 16 with coupling 20, resulting in the arrangement of FIG. 1b. The procedure becomes slightly more complicated if there are valves along the intended route—in which case, the fiber has to exit before each valve, and be channeled around the valves.

An advantage of the above technique for introducing the fiber into the pipe is that no special effort is required to direct the fiber to the intended exit point. Note that the float will follow the flow of water, and will eventually emerge where the water leaves the pipe. Routing of the fiber is accomplished automatically, by ensuring that the only point for the water to escape is the intended exit point for the fiber. Furthermore, in embodiments for which the flexible tubing (rather than the fiber itself) is pulled through the pipe, the fiber is subject to much less stress than with conventional fiber installation.

In some instances, of course, the fiber can be introduced into the pipe without recourse to the above technique. For example, in some instances it may be desired to rout a fiber from a first location on an upper floor to a second location almost directly below. This may be accomplished without the use of water, by attaching a weight to the end of the lightweight cable (or to the fiber itself) and relying on gravity.

It will be appreciated by those skilled in the art having the benefit of this disclosure that this invention is believed to present an efficient system and method for installing a data conduit in a previously existing fluid distribution pipe. The approach taken is believed to be an improvement over existing methods for installation of, e.g. optical fiber in a building, which typically require extensive modification of the building. By routing optical fiber through the existing plumbing system, it is possible to avoid such modifications. Optical fiber or new copper cable may be easily installed and well protected within the water pipes present in virtually all buildings. Typically, the plumbing extends throughout most of the building, so it may seldom be necessary to route the fiber over long distances through the walls or ceiling to reach a pipe.

Further modifications and alternative embodiments of various aspects of the invention will be apparent to those skilled in the art in view of this description. Such details as the types of pipe fittings, and the use of monofilament line are exemplary of a particular embodiment, and may be altered in other embodiments. It is intended that the following claims be interpreted to embrace all such modifications and changes and, accordingly, the specification and drawings are to be regarded in an illustrative rather than a restrictive sense.

What is claimed is:

1. A method for installing a data conduit between a first and second location within a fluid distribution pipe, the method comprising:
modifying a first segment of the fluid distribution pipe to allow the data conduit to enter said segment at an entry point near the first location; and
modifying a second segment of the fluid distribution pipe to allow the data conduit to exit said segment at an exit point near the second location.

2. The method as recited in claim 1, wherein modifying a segment of the fluid distribution pipe comprises:
bisecting the segment and inserting the end of each of the resulting two sections into one of the three legs of a wye-fitting, then inserting a coupling into the third leg of the wye-fitting, wherein the coupling is adapted to receive the data conduit and prevent fluid leakage; or
forming a hole in the pipe segment and introducing a coupling into the hole, wherein the coupling is adapted to receive the data conduit and prevent fluid leakage.

3. The method as recited in claim 2, wherein the entry point comprises the coupling inserted into the wye-fitting or introduced into the pipe segment to modify the first segment of the fluid distribution pipe.

4. The method as recited in claim 2, wherein the exit point comprises the coupling inserted into the wye-fitting or introduced into the pipe segment to modify the second segment of the fluid distribution pipe.

5. The method as recited in claim 1, wherein the fluid distribution pipe comprises a water supply pipe.

6. The method as recited in claim 1, wherein the data conduit comprises an optical fiber or copper wire jacketed within flexible tubing.

7. The method as recited in claim 1, further comprising routing the data conduit from the entry point to the exit point by:
placing a float, attached to a length of lightweight cable, in the fluid distribution pipe near the entry point;
attaching the other end of the lightweight cable to the entry point;
allowing fluid to flow through the pipe and transport the float from the entry point to the exit point; and
using the lightweight cable to pull the data conduit through the pipe from the entry point to the exit point.

8. A system for conducting a data conduit from a first to a second location within a fluid distribution pipe, comprising:
a first segment of the fluid distribution pipe, modified to allow the data conduit to enter it at an entry point near the first location; and
a second segment of the fluid distribution pipe, modified to allow the data conduit to exit it at an exit point near the second location.

9. The system as recited in claim 8, wherein a modified segment of the fluid distribution pipe comprises:
a segment that has been bisected, with the ends inserted into two of the three legs of a wye-fitting, wherein a coupling has been inserted into the third leg of the wye-fitting, such that the coupling is adapted to receive the data conduit and prevent fluid leakage;
or a segment into which a coupling has been introduced, wherein the coupling is adapted to receive the data conduit and prevent fluid leakage.

10. The system as recited in claim 9, wherein the entry point comprises the coupling inserted into the wye-fitting or introduced into the pipe segment to modify the first segment of the fluid distribution pipe.

11. The system as recited in claim 9, wherein the exit point comprises the coupling inserted into the wye-fitting or introduced into the pipe segment to modify the second segment of the fluid distribution pipe.

12. The system as recited in claim 8, wherein the fluid distribution pipe comprises a water supply pipe.

13. The system as recited in claim 8, wherein the data conduit comprises an optical fiber or copper wire jacketed within flexible tubing.

14. A method for installing a data conduit, said method comprising routing the data conduit within a fluid distribution pipe from a first location to a second location.

15. The method as recited in claim 14, wherein the fluid distribution pipe comprises a water supply pipe within a plumbing system in a building.

16. The method as recited in claim 14, wherein the fluid distribution pipe comprises a water supply pipe within an underground plumbing system.

17. The method as recited in claim 14, wherein the data conduit comprises an optical fiber jacketed within flexible tubing.

18. The method as recited in claim 14, further comprising modifying the fluid distribution pipe to provide entry and exit points.

19. The method as recited in claim 18, further comprising introducing the data conduit into the fluid distribution pipe, using said entry and exit points.

20. The method as recited in claim 18, wherein the entry and exit points comprise couplings inserted into wye-fittings interposed between segments of the fluid distribution pipe, or introduced into the fluid distribution pipe, wherein the couplings are adapted to receive the data conduit and prevent fluid leakage.

21. The method as recited in claim 20, wherein introducing the data conduit comprises:
drawing a lightweight cable through the fluid distribution pipe from the entry point to the exit point by means of a float, attached to the lightweight cable and transported by the flow of fluid through the pipe; and
pulling the data conduit through the fluid distribution pipe from the entry point to the exit point, using the previously introduced lightweight cable.
